(19) United States
(12) Patent Application Publication
(10) Pub. No.: US 2014/0028684 A1
(43) Pub. Date: Jan. 30, 2014

(54) SHORTENING A NAME FOR DISPLAY

(71) Applicant: International Business Machines Corporation, Armonk, NY (US)

(72) Inventor: Mickael Maison, Southhampton (GB)

(21) Appl. No.: 13/936,160

(22) Filed: Jul. 6, 2013

(30) Foreign Application Priority Data
Jul. 30, 2012 (GB) 1213530.7

(51) Int. Cl. G06T 11/60

(52) U.S. Cl. CPC G06T 11/60
USPC 345/467

(57) ABSTRACT

A method and system are provided for shortening a name for display. The method may include: determining a size of a display area in which a name is to be displayed; receiving a name string for display and shortening the name string to fit into the display area. Shortening the name string may include: replacing one or more words in the name string with an acronym; and removing or replacing non-distinctive elements in the name string. The method may include receiving two or more name strings to be displayed; and wherein removing or replacing non-distinctive elements in the name string includes: comparing the names and removing or replacing the non-unique elements of the name strings.

### BACKGROUND

The way to identify files in modern operating systems is usually by their names. When there is not enough space on the screen to display the full file name, the name is cropped. When file names start with the same letters, the user does not have a way to identify a unique file as several files may appear to have the same name. For example, a folder may contain the following files: “application1”, “application2” and “appointment”, and if the files are cropped after the 3rd letter, they all appear the same as “app”. This also applies to contact names or other strings used for display. The term “file name” is intended to include all forms of string names.

### BRIEF SUMMARY

According to a first aspect of the present invention there is provided a method for shortening a name for display, comprising: determining a size of a display area in which a name is to be displayed; receiving a name string for display and shortening the name string to fit into the display area; wherein shortening the name string includes: replacing one or more words in the name string with an acronym; and removing or replacing one or more non-distinctive elements in the name string.

According to a second aspect of the present invention there is provided a system for shortening a name for display, comprising: a display area determining component for determining a size of a display area in which a name is to be displayed; a name input component for receiving a name string for display and a name shortening component for shortening the name string to fit into the display area; wherein the name shortening component includes: an acronym component for replacing one or more words in the name string with an acronym; and a non-distinctive element component for removing or replacing non-distinctive elements in the name string.

According to a third aspect of the present invention there is provided a computer program product for shortening a name for display, the computer program product comprising a computer readable storage medium having computer-readable program code embodied therewith, the computer-readable program code configures to: determine a size of a display area in which a name is to be displayed; receive a name string for display and shortening the name string to fit into the display area; wherein shortening the name string includes: replacing one or more words in the name string with an acronym; and removing or replacing non-distinctive elements in the name string.

Viewed from a further aspect, the present invention provides a computer program product for shortening a name for display, the computer program product comprising: a computer readable storage medium readable by a processing circuit and storing instructions for execution by the processing circuit for performing a method for performing the steps of the invention.

Viewed from a further aspect, the present invention provides a computer program stored on a computer readable medium and loadable into the internal memory of a digital computer, comprising software code portions, when said program is run on a computer, for performing the steps of the invention.

The described aspects of the invention provide the advantage of preserving a file name's uniqueness whilst fitting in an available display area.

### BRIEF DESCRIPTION OF THE SEVERAL VIEWS OF THE DRAWINGS

For a more complete understanding of the present application, the objects and advantages thereof, reference is now made to the following descriptions taken in conjunction with the accompanying drawings, in which:

FIG. 1 is a flow diagram of an example embodiment of a method in accordance with the present invention;

FIG. 2 is a flow diagram of an example embodiment of a method in accordance with the present invention;

FIG. 3 is block diagram of an example embodiment of a system in accordance with the present invention; and

FIG. 4 is a block diagram of an embodiment of a computer system in which the present invention may be implemented.

### DETAILED DESCRIPTION

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Method and system are provided for automatically computing shortened names for display. This may be particularly applied to shortening of multiple names that would otherwise appear the same if cropped from the right. The shortened display names may be displayed to the user as a replacement. Using this technique, the user can differentiate files or objects even when there is not enough space on the screen to display the full name.

Multiple ways can be used and combined to shorten the names. One step may be to check if a series of words in a name could be replaced by a known acronym. Another step may be, instead of cropping from the right, as it is usually done, the cropping could be done in the middle of the name to preserve the name differences, or from the left. Another step may be to remove non-distinctive elements from the name. This may include non-distinctive elements such as common words or elements which are non-distinctive as they are not unique to a name. This non-uniqueness may be determined by comparing string sequences of two or more names and removing the common elements.

The described method shortens names (which may be file names, contact names, or other strings), when there is not enough space on a screen to display them entirely, in a way that the shortened names keep their uniqueness.

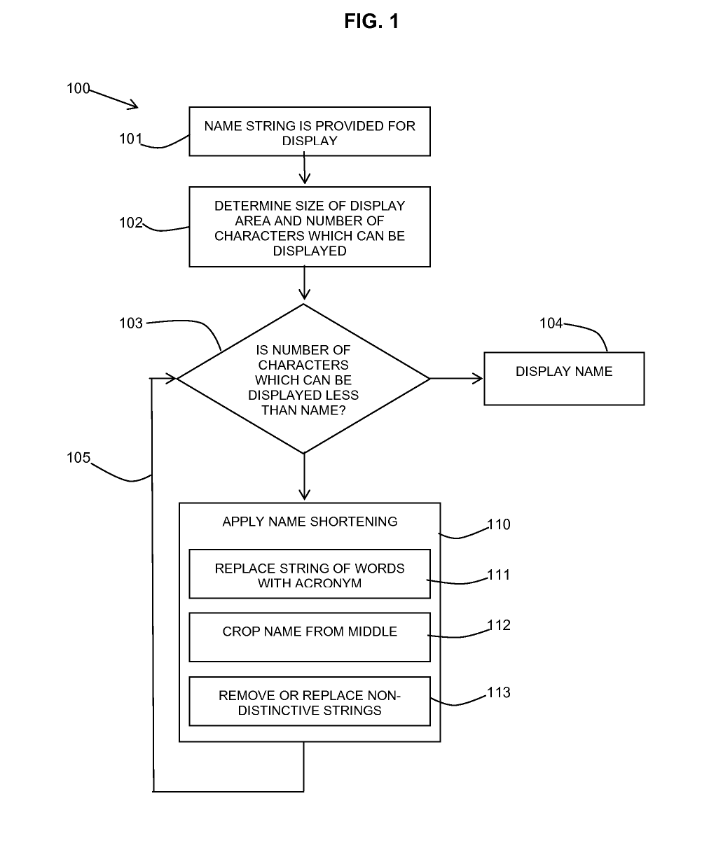

Referring to FIG. 1, a flow diagram 100 shows an example embodiment of the described method. A name string is provided 101 to be displayed in a display area of a graphical user interface. The name string may be selected, entered, copied, etc. The name string may be a file name, a contact name, or any other string which is required to be displayed on a graphical user interface.

The graphical component of an operating system may determine 102 the size (in pixel) that is available to display names. As it also knows the font used to render the names, it can calculate how many characters can be displayed. It may then be determined 103 if this number is smaller than the name length. If it is not smaller, then the name may be displayed 104. However, if it is smaller, then name shortening needs to be applied 110.

Name shortening 110 may include one or more of the following methods. These method may be applied in any order and may be tried iteratively 105 until the name string is shortened sufficiently to be displayed 104.

A string of words may be replaced 111 with an acronym. Words may be identified as they tend to be separated by spaces, underscores, dots, dashes, etc. The first letter of each word may also be uppercased leading to identification of an acronym. Also file names may be matched against a database of commonly used acronyms. This database may be crowd-sourced.

In another method, instead of cropping from the right, as it is usually done, cropping may be carried out 112 in the middle of the file name or from the left to preserve unique parts of name which may often occur at the end of the name.

In another method, non-distinctive strings may be recognized 113 and removed or replaced, for example, they may be replaced by a marker, initial, or shortened version. The non-distinctive strings may be recognized by comparing to a provided list of non-distinctive or commonplace terms, such as “file”, “application”, “version”, etc.

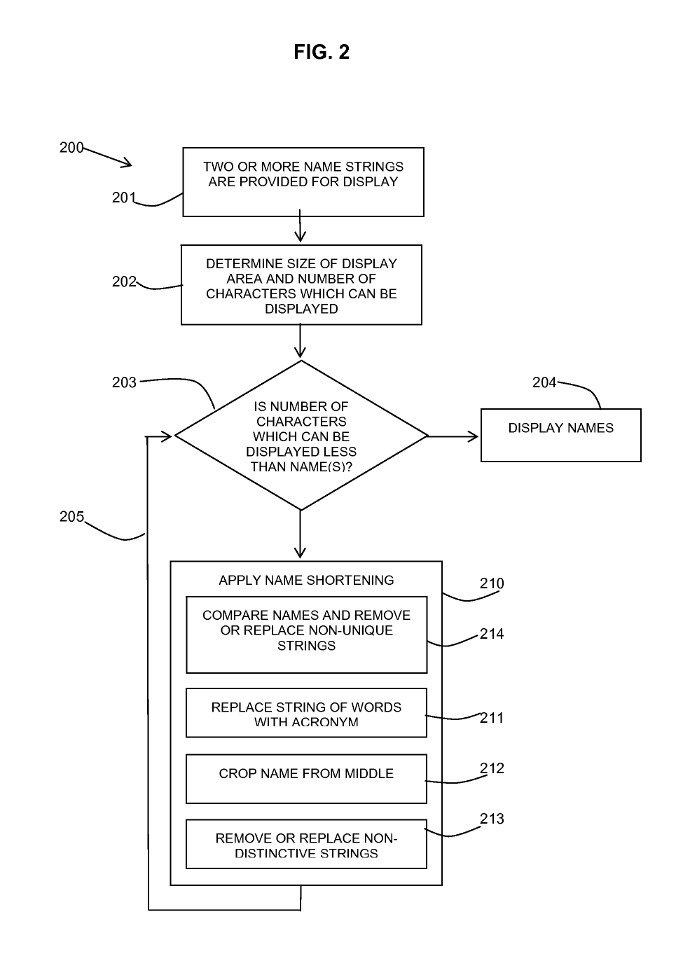

Referring to FIG. 2, a flow diagram 200 shows another example embodiment of the described method. In this embodiment, two or more name strings may be provided 201 which are each to be displayed in a display area of a graphical user interface.

The graphical component of an operating system may determine 202 the size (in pixel) that is available to display names. As it also knows the font used to render the names, it can calculate how many characters can be displayed. It may then be determined 203 if this number is smaller than the names' lengths. If it is not smaller, then the names may be displayed 204. However, if it is smaller, then name shortening needs to be applied 210.

In this embodiment, name shortening 210 by removing or replacing non-distinctive strings may include removing 214 non-unique elements of the names by comparing the names and determining identical or similar elements. In addition, the name shortening may also include the method of the first embodiment described in relation to FIG. 1. These method may be applied in any order and may be tried iteratively 205 until the names are shortened sufficiently to be displayed 204.

In the comparison method, names may be compared and non-unique strings may be removed 214. This may be done by first determining the unique parts of the two names. This may be carried out by starting from the first character of each name and comparing the characters. If they are the same, this character may be discarded, if not, this character may be marked as unique. There are many other methods that may be used to produce distinguishable strings.

A string of words may be replaced 211 with an acronym, as described in relation to FIG. 1.

In another method, cropping may be carried out 212 in the middle of the file name to preserve unique parts of name which may often occur at the end of the name, as described in relation to FIG. 1.

In another method, non-distinctive strings may be recognized 213 and removed or replaced, as described in relation to FIG. 1 by referencing a list of non-distinctive or commonplace words.

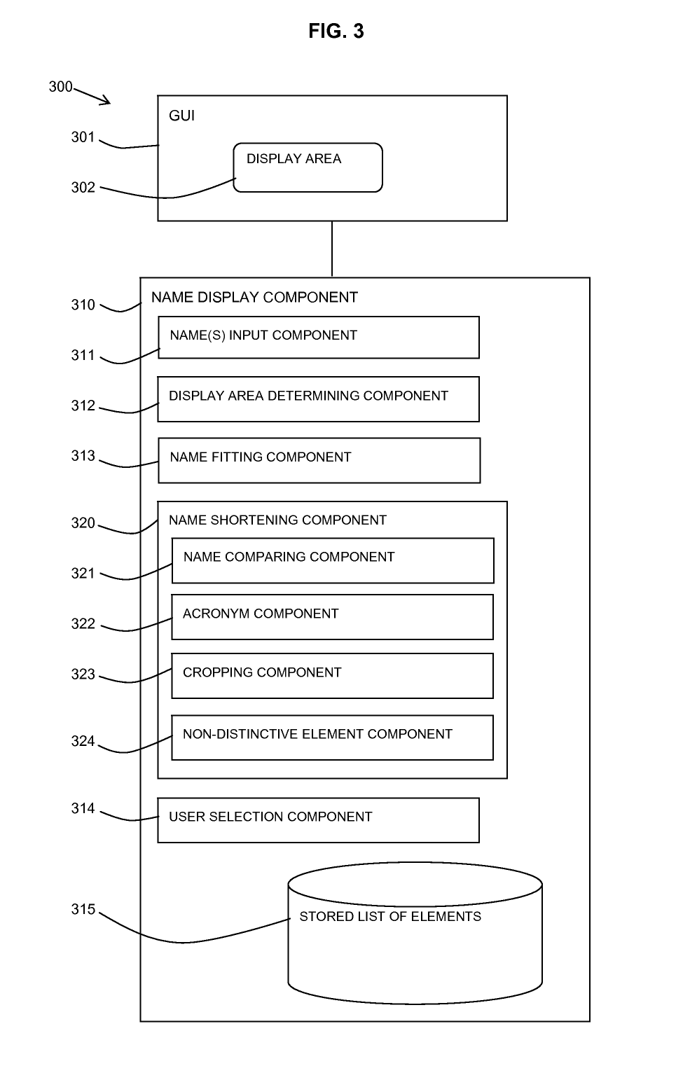

Referring to FIG. 3, a block diagram shows an example embodiment of the described system 300. A graphical user interface (GUI) 301 has a display area 302 for displaying a name.

A name display component 310 is described for displaying one or more names in an area the size of the display area 302. There may be multiple names which are to be displayed in multiple display area 302 of the same size, in which case, the names are compared and shortened using a common procedure for all the names. Alternatively, there may only be one name to be displayed.

The name display component 310 may include a name(s) input component 311 for receiving one or more names to be displayed. A display area determining component 312 may determine the number of characters of a name which can be displayed in a display area 302 given the font, etc. A name fitting component 313 may determine if a name fits in the display area 302. The name fitting component 313 may test the name iteratively during the name shortening process to see if the name fits.

A name shortening component 320 may be provided for shortening the name or names provided for display. The name shortening component 320 may use one or more sub-components which shorten the name using different methods.

If the system accommodates two or more names for display, the name shortening component 320 may include a name comparing component 321 may be provided for comparing the names and removing non-unique strings from the names.

If the system accommodates one or multiple names, the name shortening component 320 may include one or more of: an acronym component 322 for replacing words in a name with an acronym, a cropping component 323 for cropping a name from the middle or left of the name, and a non-distinctive element component 324 for removing or replacing non-distinctive strings in a name.

A storage area may provide a stored list of elements 315 for reference by the name shortening component 320. In particular, the stored list of elements 315 may include a list of known acronyms for use by the acronym component 322. It may also or alternatively include a list of non-distinctive elements for use by the non-distinctive element component 324.

The name display component 310 may include a user selection component 314 for providing one or more proposed shortened name strings to a user for selection. The proposed names may be provided to a user via the GUI 301.

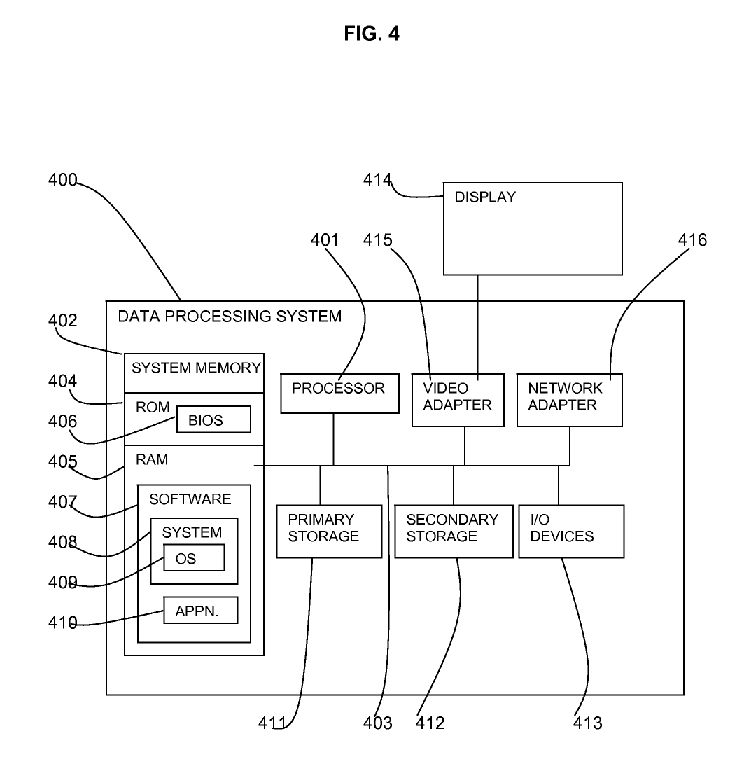

Referring to FIG. 4, an exemplary system for implementing aspects of the invention includes a data processing system 400 suitable for storing and/or executing program code including at least one processor 401 coupled directly or indirectly to memory elements through a bus system 403. The memory elements may include local memory employed during actual execution of the program code, bulk storage, and cache memories which provide temporary storage of at least some program code in order to reduce the number of times code must be retrieved from bulk storage during execution.

The memory elements may include system memory 402 in the form of read only memory (ROM) 404 and random access memory (RAM) 405. A basic input/output system (BIOS) 406 may be stored in ROM 404. System software 407 may be stored in RAM 405 including operating system software 408. Software applications 410 may also be stored in RAM 405.

The system 400 may also include a primary storage means 411 such as a magnetic hard disk drive and secondary storage means 412 such as a magnetic disc drive and an optical disc drive. The drives and their associated computer-readable media provide non-volatile storage of computer-executable instructions, data structures, program modules and other data for the system 400. Software applications may be stored on the primary and secondary storage means 411, 412 as well as the system memory 402.

The computing system 400 may operate in a networked environment using logical connections to one or more remote computers via a network adapter 416.

Input/output devices 413 may be coupled to the system either directly or through intervening I/O controllers. A user may enter commands and information into the system 400 through input devices such as a keyboard, pointing device, or other input devices (for example, microphone, joy stick, game pad, satellite dish, scanner, or the like). Output devices may include speakers, printers, etc. A display device 414 is also connected to system bus 403 via an interface, such as video adapter 415.

In this described method where there are multiple names, when there is enough space on the screen to display the full names, the full names may be displayed, for example, FileA and FileB. If the display window is resized and the full names cannot be displayed entirely, then the non-unique part of the files may be replaced by a marker and the unique part of the file's name may be kept. The marker may signal the user that the file name has been cropped.

In an example, the full names may be “FileA” and “FileB”. The shortest names this can give are ˜A and ˜B. Any intermediate length is also valid, for example, Fi˜A, Fil˜A. Multiple non-unique parts may also be replaced. For example, FileAVersion1 and FileBVersion2 may be shortened to F˜A˜1 and F˜B˜2.

The described method breaks the link between a file name and a short name, effectively creating a third identifier, the ‘display name’, which provides a more intuitive way of distinguishing between files with similar names.

The advantage lies in the ability to pick out portions of the unique parts of the name and combine them with some subset of the non-unique parts to allow the user to guess more accurately the corresponding full name.

The described method also has the benefit that names may be shortened to different display names depending on the size of the display they are to be displayed in. This maximizes the distinctiveness of the name by not unnecessarily shortening a name.

### EXAMPLE 1

This example shows three names which are to be displayed. The symbol | represents the sides of the display area (IBM is a trade mark of International Business Machines Corporation). The following are examples of ways the names may be shortened.
   |International_Business_Machines_report1.txt|
   |International_Business_Machines_report2.txt|
   |International_Business_Machines_plan.txt|

A first shortening step may be carried out to replace the non-unique strings of “report” with the initial “r”.
   |International_Business_Machines_r˜1.txt|
   |International_Business_Machines_r˜2.txt|
   |International_Business_Machines_plan.tx|

As an alternative or additional shortening step, in this example the string of “International_Business_Machines” may be replaced with the acronym “IBM”. The capitalization of the words together with the underscore separating the words leads to a recognition of a string for which an acronym may be used. In addition, “IBM” may be in a list of known acronyms which may be referenced.
   |IBM_report1.txt
   |IBM_report2.txt
   |IBM_plan.txt

It may then be noted that the acronym, “IBM” is non-unique to the three names and may be replaced by an initial “I”.
   |I_r˜1.txt|
   |I_r˜2.txt|
   |I_plan.tx|

In another option, the “IBM” may be removed completely which may provide enough space to include the word “report” to remain.
   |˜report1|
   |˜report2|
   |˜plan|

A final, very short version may be displayed with the word “report” removed and the word “plan” replaced by the initial.
   |I˜1|
   |I˜2|
   |I˜p|

The choice of how much of the non-unique part to show would need to be tuned to play off length against clarity. The shortened name versions may be provided to a user to determine their preference for display.

### EXAMPLE 2

In this example, two file names may be provided:
File1SooXYZ20111112
File2SooXYZ20111113

Removing the non-unique strings may result in:
Fil˜1˜2
Fil˜2˜3

However, leaving some of the non-unique characters may increase clarity as:
Fil˜1Soo˜2
Fil˜2Soo˜3

### EXAMPLE 3

In this example, shortening of the name string is illustrated from the middle or left. Three file names may be provided:
   |report-201201|
   |report-201112|
   |report-201111|

Once cropped and resized these may still contain the distinctive elements at the right of the names:
   |∥201201|
   |˜201112|
   |˜201111|

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

The invention can take the form of a computer program product accessible from a computer-usable or computer-readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read only memory (ROM), a rigid magnetic disk and an optical disk. Current examples of optical disks include compact disk read only memory (CD-ROM), compact disk read/write (CD-R/W), and DVD.

Improvements and modifications can be made to the foregoing without departing from the scope of the present invention.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java®, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). Java and all Java-based trademarks and logos are trademarks or registered trademarks of Oracle and/or its affiliates.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

For the avoidance of doubt, the term “comprising”, as used herein throughout the description and claims is not to be construed as meaning “consisting only of”.

What is claimed is:

1. A method for shortening a name for display, comprising:
determining a size of a display area in which a name is to be displayed; and
receiving a name string for display and shortening the name string to fit into the display area; and
wherein shortening the name string includes:
replacing one or more words in the name string with an acronym; and
removing or replacing one or more non-distinctive elements in the name string.

2. The method as claimed in claim 1, further comprising:
receiving two or more name strings to be displayed; and
wherein removing or replacing one or more non-distinctive elements in the name string includes comparing the names and removing or replacing the non-distinctive elements of the name strings.

3. The method as claimed in claim 1, wherein replacing a non-distinctive element replaces the element with an initial or abbreviation.

4. The method as claimed in claim 1, wherein a non-distinctive element is determined by comparing to a list of terms.

5. The method as claimed in claim 1, wherein replacing one or more words in the name string with an acronym, includes:
identifying multiple words in the name string; and
replacing the words with their initials.

6. The method as claimed in claim 1, wherein replacing one or more words in the name string with an acronym includes matching multiple words with a list of words to be replaced by a given acronym.

7. The method as claimed in claim 1, wherein shortening the name string includes cropping a name string from the middle of the string.

8. The method as claimed in claim 1, further comprising interactively testing if the shortened name string fits in the display area.

9. The method as claimed in claim 1, further comprising providing one or more proposed shortened name strings to a user for selection.

10. A system for shortening a name for display, comprising:
a display area determining component for determining a size of a display area in which a name is to be displayed;
a name input component for receiving a name string for display and a name shortening component for shortening the name string to fit into the display area;
wherein the name shortening component includes:
an acronym component for replacing one or more words in the name string with an acronym; and
a non-distinctive element component for removing or replacing non-distinctive elements in the name string.

11. The system as claimed in claim 10, wherein the name input component is for receiving two or more name strings to be displayed; and
wherein the name shortening component includes a name comparing component for comparing the names and removing or replacing the non-unique elements of the name strings.

12. The system as claimed in claim 10, further comprising a stored list of elements including a list of non-distinctive terms.

13. The system as claimed in claim 10, wherein the acronym component is for:
identifying multiple words in the name string; and
replacing the words with their initials.

14. The system as claimed in claim 10, wherein the acronym component is for matching multiple words with a list of words to be replaced by a given acronym.

15. The system as claimed in claim 10, wherein the name shortening component includes a cropping component for cropping a name string from the middle of the string.

16. The system as claimed in claim 10, further comprising a name fitting component for interactively testing if the shortened name string fits in the display area.

17. The system as claimed in claim 10, further comprising a user selection component for providing one or more proposed shortened name strings to a user for selection.

18. A computer program product for shortening a name for display, the computer program product comprising:
a computer readable storage medium readable by a processing circuit and storing instructions for execution by the processing circuit for performing a method comprising:
determining a size of a display area in which a name is to be displayed; and
receiving a name string for display and shortening the name string to fit into the display area; and
wherein shortening the name string includes:
replacing one or more words in the name string with an acronym; and
removing or replacing one or more non-distinctive elements in the name string.

19. The computer program product as claimed in claim 18, wherein the instructions are executable by the processing circuit for:
receiving two or more name strings to be displayed; and
wherein removing or replacing one or more non-distinctive elements in the name string includes comparing the names and removing or replacing the non-distinctive elements of the name strings.

20. The computer program product as claimed in claim 18, wherein the instructions are executable by the processing circuit for interactively testing if the shortened name string fits in the display area.
